(19) United States
(12) Patent Application Publication
(10) Pub. No.: US 2004/0119919 A1
(43) Pub. Date: Jun. 24, 2004

(54) Method for manufacturing a light guide plate using injected gas

(76) Inventor: Fang-Jwu Liao, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/731,617

(22) Filed: Dec. 8, 2003

(30) Foreign Application Priority Data
Dec. 16, 2002 (TW) 91135347

(51) Int. Cl. G02F 1/1335

(52) U.S. Cl. 349/113

(57) ABSTRACT

A method for manufacturing a light guide plate (41, 51, 61) includes the steps of providing a mold (20), melting resin material and mixing an inert gas into the molten resin material, injecting the mixture of the molten resin material and the inert gas into a cavity (26) of the mold, cooling the mold under a constant pressure, and demolding and taking the light guide plate out from the mold. The inert gas decreases the viscosity of the molten resin material, so that the light guide plate is formed with high uniformity. In addition, because the molten resin material is mixed with the inert gas, the formed light guide plate is lighter in weight. Moreover, no printing process is required. This means that the time needed for production is shortened, and the costs of producing the light guide plate is reduced.

### BACKGROUND OF THE INVENTION

1. Field of the Invention

The present invention relates to methods for manufacturing light guide plates, and more particularly to low-cost methods for manufacturing light guide plates that are light in weight.

2. Description of the Prior Art

A liquid crystal display is capable of displaying a clear and sharp image through millions of pixels of image elements. It has thus been applied to various electronic equipment in which messages or pictures need to be displayed, such as in mobile phones and notebook computers. However, liquid crystals in the liquid crystal display do not themselves emit light. Rather, the liquid crystals have to be lit up by a light source so as to clearly and sharply display text and images. The light source may be ambient light, or part of a backlight system attached to the liquid crystal display.

A conventional backlight system generally comprises a plurality of components, such as a light source, a reflective plate, a light guide plate, a diffusion plate and a prism layer. Among these components, it is generally believed that the light guide plate is the most crucial component in determining the performance of the backlight system. The light guide plate serves as an instrument for receiving light beams from the light source, and for evenly distributing the light beams over the entire light guide plate through reflection and diffusion. In order to keep light evenly distributed over an entire surface of the associated liquid crystal display, the diffusion plate is generally arranged on top of the light guide plate.

Conventionally, there are two important kinds of methods for manufacturing a light guide plate: printing processes and non-printing processes. In a typical printing process, marks are coated on a bottom surface of a transparent plate, so as to form an array of dots that can scatter and reflect incident light beams. The dots can totally eliminate internal reflection of the light beams, and make the light beams evenly emit from a light emitting surface of the transparent plate. However, t quality of printing is difficult to control, and printing processes are gradually being replaced by non-printing processes.

A typical non-printing process includes forming an array of holes on an internal face of a mold. The mold thus produces a light guide plate having an array of dots integrally formed thereon. During the molding process, a viscosity of molten resin material affects the uniformity of the subsequently formed light guide plate. That is, if the viscosity of the molten resin is high, some of the molten resin is liable to solidify before all the molten resin has been evenly distributed in a cavity of the mold. Moreover, if the formed light guide plate is thin, it is liable to warp after it has been cooled and removed from the mold.

### SUMMARY OF THE INVENTION

It is therefore an objective of the present invention to provide a method for manufacturing a light guide plate that has a highly uniform structure.

Another objective of the present invention to provide an inexpensive method for manufacturing a light guide plate that is light in weight.

In order to achieve the above objectives, a method for manufacturing a light guide plate in accordance with the present invention generally includes the steps of providing a mold, melting resin material and mixing an inert gas into the molten resin material, injecting the mixture of the molten resin material and the inert gas into a cavity of the mold, cooling the mold under a constant pressure, and demolding and taking the light guide plate out from the mold.

The mixture of the molten resin material and the inert gas is rapidly injected into the cavity of the mold. The inert gas decreases the viscosity of the molten resin material, so that the light guide plate is formed with high uniformity. In addition, because the molten resin material is mixed with the inert gas, the density of the formed light guide plate is decreased. That is, the light guide plate is lighter in weight. Moreover, no printing process is required. This means that the time needed for production is shortened, and the costs of producing the light guide plate are reduced.

Other objects, advantages and novel features of the present invention will be apparent from the following detailed description of preferred embodiments thereof with reference to the attached drawings, in which:

### BRIEF DESCRIPTION OF THE DRAWINGS

FIG. 1 is substantially a cut-away view of a device used in a method for manufacturing a light guide plate in accordance with the present invention;

FIG. 2 is a flow chart of the method for manufacturing a light guide plate of the present invention;

FIG. 3 is a side elevation of a parallelepiped-shaped light guide plate formed in accordance with the present invention;

FIG. 4 is a side elevation of a wedgy light guide plate formed in accordance with the present invention; and

FIG. 5 is a side elevation of a symmetrically narrowed light guide plate formed in accordance with the present invention;

### DETAILED DESCRIPTION OF THE INVENTION

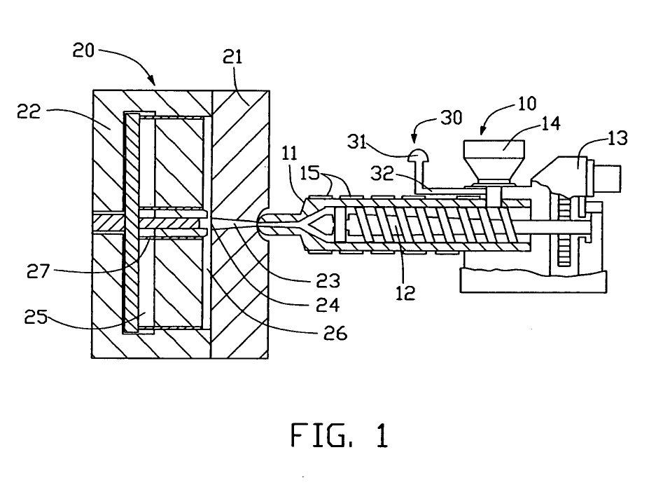

Referring to FIG. 1, a device used in a method for manufacturing a light guide plate in accordance with the present invention includes an injector 10, a mold 20 and a inflator 30. The injector 10 includes a sleeve 11, a rotatable screw 12 inside the sleeve 11, a motor 13 driving the screw 12, a hopper 14 supplying resin material to the sleeve 11, and a plurality of heaters 15 located around an outside of the sleeve 11. The mold 20 includes a cover half 21, a moving die 22, a plurality of projections 27, a runner 23 through which molten resin can pass, and a sprue 24 communicating with the runner 23. The cover half 21 and the moving die 22 cooperatively define a cavity 26 therebetween, which is used for forming the light guide plate (not shown). The moving die 22 defines a channel 25 therein distal from the cover half 21. The channel 25 provides space which enables the projections 27 to be moved toward the cover half 21, so that the projections 27 can eject a formed light guide plate from the mold 20. The inflator 30 includes a gas passage 31 and a gas cavity 32. The gas passage 31 is connected to the sleeve 11 when the sleeve 11 is charged with gas.

A surface of moving die 22 at the cavity 26 has holes (not shown) formed thereon, so as to form light guide plates having corresponding dots. The holes are hemispherical or sub-hemispherical. In an alternative embodiment, the holes may have other forms such as being cylindrical, cuboid, parallelepiped-shaped, or frustum-shaped. The holes are formed by way of coining, abrasive blasting, etching, milling, or electroforming. In addition, said surface may be substantially a single orthogonal plane, a single slanted plane, or two symmetrical, connected planes that slant toward each other. The mold 20 is made of a metal having a high coefficient of heat transfer, such as copper, a copper alloy or beryllium copper. In alternative embodiments, in order to improve the rigidity of the mold 20, the mold 20 may be made of nickel, a nickel-cobalt alloy, silicon carbide, chrome, or titanium carbide.

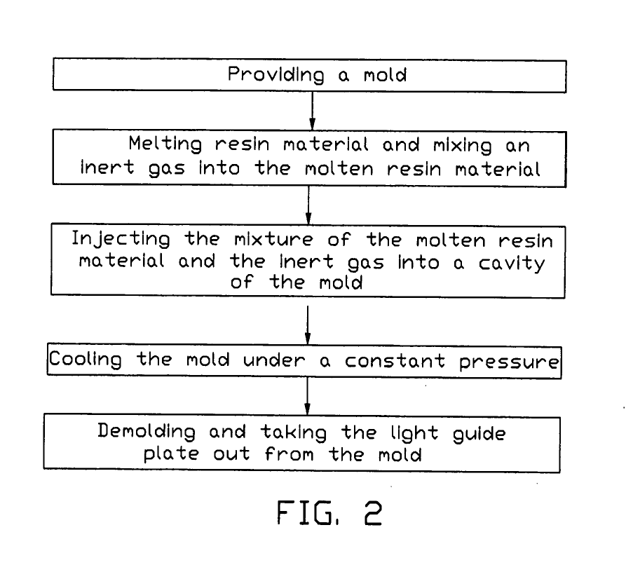

Referring to FIGS. 1 and 2, a method for manufacturing a light guide plate includes the steps of providing the mold 20, melting resin material and mixing an inert gas into the molten resin material, injecting the mixture of the molten resin material and the inert gas into the cavity 26 of the mold 20, cooling the mold 20 under a constant pressure, and demolding and taking the light guide plate out from the mold 20. Details are as follows:

First, providing the mold 20, which is described above.

Second, melting resin material and mixing an inert gas into the molten resin material. The resin material is a thermoplastic resin having high transparence, such as methacrylate resin, polycarbonate, polystyrene, polypropylene or polyethylene. The resin material is mixed with a demolding agent, an ultraviolet absorbent, a dye, and an antioxidant, so that the formed light guide plate is readily formed with excellent optical performance.

The prepared resin material is continuously perfused from the hopper 14 into the sleeve 11, and is heated by the heaters 15. In the preferred embodiment, the resin material is methacrylate resin. A melting temperature of the methacrylate resin is in the range from 170˜300° C., and preferably in the range from 230˜260° C. The sleeve 11 is charged with the inert gas while the motor 12 drives the screw 12 to rotate, so as to sufficiently mix the molten resin material and the inert gas and push the mixture to an output end of the sleeve 11.

The inert gas is argon (Ar), helium (He), or neon (Ne). In an alternative embodiment, nitrogen may be used instead of an inert gas. Before being charged into the sleeve 11, the inert gas is heated to a temperature in the range from 100˜120° C., preferably 110° C.

Third, injecting mixture of the molten resin material and the inert gas into the cavity 26 of the mold 20. The mixture of the molten resin material and the inert gas is rapidly injected into the cavity 26 of the mold 20. An injecting speed is in the range from 1000˜2500 cm³/s. A viscosity of the molten resin material when it is in the sprue 24 is in the range from 50˜5000 Pa.sec, and preferably in the range from 200˜1000 Pa.sec.

Fourth, cooling the mold 20 under a constant pressure. Once the molten resin has been injected into the cavity 26, the screw 12 is adjusted so as to stabilize the pressure in the cavity 26. The mold 20 is cooled using a cooling device (not shown). The cooling temperature is below 110° C., preferably 105° C. After cooling is completed, the light guide plate is formed.

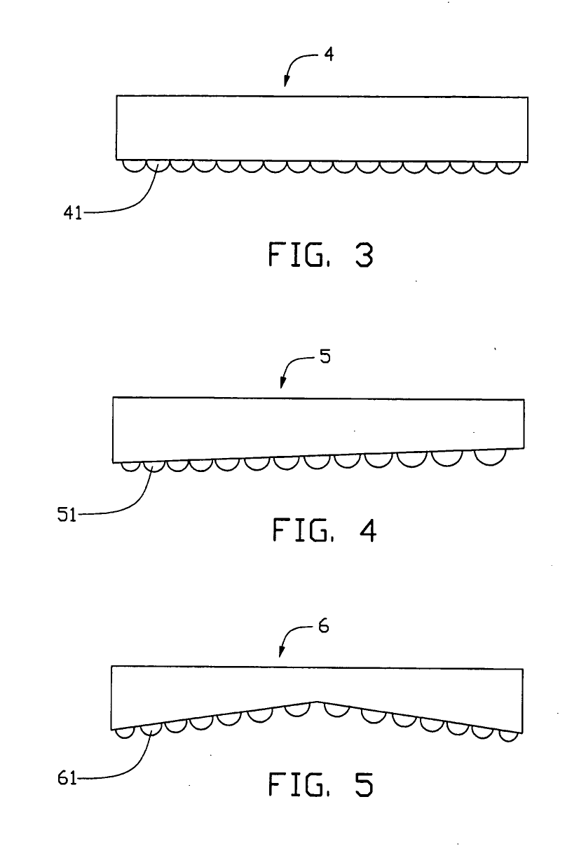

Fifth and finally, demolding and taking the light guide plate out from the mold 20. Referring to FIGS. 3, 4 and 5, said surface of the moving die 22 of the mold 20 can produce a variety of light guide plates. FIG. 3 shows a parallelepiped-shaped light guide plate 4 produced when said surface is substantially a single orthogonal plane. FIG. 4 shows a wedgy light guide plate 5 produced when said surface is substantially a single slanted plane. FIG. 5 shows a symmetrically narrowed light guide plate 6 produced when said surface is substantially two symmetrical, connected planes that slant toward each other. The light guide plate 4, 5, 6 respectively includes reflecting dots 41, 51, 61. The dots 41 of the parallelepiped-shaped light guide plate 4 are evenly distributed on a bottom surface thereof. The dots 51 of the wedgy light guide plate 5 and the dots 61 of the symmetrically narrowed light guide plate 6 are unevenly distributed on respective bottom surfaces thereof.

In summary, the mixture of the molten resin and the inert gas is injected into the cavity 26 of the mold 20. The inert gas decreases the viscosity of the molten resin, so that the light guide plate 4, 5, 6 is formed with high uniformity. In addition, because the molten resin is mixed with the inert gas, the density of the formed light guide plate 4, 5, 6 is decreased. That is, the light guide plate 4, 5, 6 is lighter in weight. Moreover, no printing process is required. This means that the time needed for production is shortened, and the costs of producing the light guide plates 4, 5, 6 are reduced.

It is to be understood that even though numerous characteristics and advantages of the present invention have been set out in the foregoing description, together with details of the structure, function and method of the invention, the disclosure is illustrative only, and changes may be made in detail, especially in matters of shape, size and arrangement of parts within the principles of the invention to the full extent indicated by the broad general meaning of the terms in which the appended claims are expressed.

We claim:

1. A method for manufacturing a light guide plate, comprising:
providing a mold;
melting resin material and mixing an inert gas into the molten resin material;
injecting mixture of the molten resin material and the inert gas into a cavity of the mold;
cooling the mold under a constant pressure; and
demolding and taking the light guide plate out from the mold.

2. The method for manufacturing a light guide plate as recited in claim 1, wherein the inert gas is argon (Ar), helium (He), or neon (Ne).

3. The method for manufacturing a light guide plate as recited in claim 1, further comprising the step of heating the inert gas before mixing it into the molten resin material.

4. The method for manufacturing a light guide plate as recited in claim 3, wherein the inert gas is heated to a temperature in the range from 100˜120° C.

5. The method for manufacturing a light guide plate as recited in claim 4, wherein the inert gas is heated to a temperature of 110° C.

6. The method for manufacturing a light guide plate as recited in claim 1, wherein when the mixture of the molten resin material and the inert gas is injected into the cavity, a viscosity of the molten resin material is in the range from 50˜5000 Pa.sec.

7. The method for manufacturing a light guide plate as recited in claim 6, wherein said viscosity of the molten resin is in the range from 200˜1000 Pa.sec.

8. The method for manufacturing a light guide plate as recited in claim 1 wherein the mold is made of a metal having a high coefficient of heat transfer.

9. The method for manufacturing a light guide plate as recited in claim 8, wherein the mold is made of copper, a copper alloy, or beryllium copper.

10. The method for manufacturing a light guide plate as recited in claim 1, wherein the mold is made of nickel, a nickel-cobalt alloy, silicon carbide, chrome, or titanium carbide.

11. The method for manufacturing a light guide plate as recited in claim 1, wherein the resin material is methacrylate resin.

12. The method for manufacturing a light guide plate as recited in claim 11, wherein a melting temperature of the molten methacrylate resin is in the range from 170˜300° C.

13. The method for manufacturing a light guide plate as recited in claim 12, wherein said temperature is in the range from 230˜260° C.

14. A method of making an optical element via injection molding, comprising steps of:
injecting melted resin material mixed up with at least one inert gas into a mold;
cooling the mold; and
obtaining a molded optical element essentially made of resin with at least one inert gas involved therewith, wherein said molded optical element has a smaller density than those made of resin via injection molding without any inert gas involved therewith.

15. The method as described in claim 14, wherein a viscosity of said melted resin material is reduced via said at least one inert gas during molding.
